(19) United States
(12) Patent Application Publication
(10) Pub. No.: US 2011/0047709 A1
(43) Pub. Date: Mar. 3, 2011

(54) SUPPORT DEVICE WITH ADJUSTABLE LENGTH AND WIDTH

(76) Inventors: Jean-Francois Tarsaud, Peypin (FR); Sylvian Nozieres, Montpellier (FR); Florian Garnero, Castries (FR); Gilles Camus, Montpellier (FR); Thierry Flocard, Montpellier (FR)

(21) Appl. No.: 12/870,369

(22) Filed: Aug. 27, 2010

(30) Foreign Application Priority Data
Aug. 31, 2009 (FR) 0955934

(51) Int. Cl. A47C 27/10; G01B 1/00

(52) U.S. Cl. 5/710; 33/700

(57) ABSTRACT

A support device capable of supporting a patient, includes a mattress resting or capable of resting on a bed base or bed frame and further includes means for adjustment of the length of the mattress by means of pneumatically independent inflatable transverse cells comprising an area known as a retractable area, means for grouped movement of an end area adjacent to said retractable area, and means for adjustment of the width of the mattress, including at least one lateral inflatable cell, extending in the longitudinal direction of the mattress.

### CROSS-REFERENCE TO RELATED APPLICATIONS

The present application claims priority, under 35 U.S.C. §119(a), of French National Application No. 0955934 which was filed Aug. 31, 2009 and which is hereby incorporated by reference herein.

### BACKGROUND

The present disclosure relates to support devices used in beds and chairs adapted for medical use. More particularly, the present disclosure relates to a therapeutic support device including a mattress resting on a level base or frame.

Some mattresses include a plurality of transverse more or less cylindrical, inflatable cells, each extending in a direction perpendicular to the longitudinal direction of the mattress, said transverse cells being positioned side by side in the longitudinal direction of the mattress, the support device also including means for inflating said cells and, in some embodiments, electronic means for regulating the air pressure within said cells, such as, for example, according to the morphology of the patient lying on said mattress.

In such support devices, each cell is equipped in a known manner with an air feed orifice and an air evacuation orifice, which communicate in a substantially airtight manner through hoses and by means of electromagnetic valves opening or closing said orifices, with an inflating device, such as a pump and electronic control devices for said pump and said electromagnetic valves.

The support devices of this type are used as mattresses for caring for patients, because they make it possible to provide an adequate distribution of the interface pressure, that is to say, a pressure exerted locally by each point of the body on the surface of the mattress, according to the morphology and the position of the patients. Such mattresses specifically make it possible, depending on the number of inflatable cells implemented, to individually control the pressure and thus the filling of the inflatable cells in the different areas of the mattress in order to obtain a distribution of the interface pressure suited to the level of each of the parts of the body of a patient and to avoid or reduce the risk of formation of bedsores in a patient at risk, for example in the vulnerable regions of the body, such as the sacrum and the heels.

Theoretically, the ideal comfort of a patient and the optimum vascularization in order to prevent the formation of bedsores or to reduce localized pains in certain support areas of the body on the mattress, are obtained when the support points of the body are redistributed over the surface of the mattress, that is to say, when the pressure exerted by the various areas of the body on the mattress (called “interface pressure”) are more or less identical for all the points of the body surface in contact with the mattress and, if moreover, such surface contact of the body with the mattress is as great as possible, which requires the adapting of the inflatable cells of the mattress under the various parts of the body to control the level of penetration of the body into the different areas of the mattress.

To accomplish this, the air pressure within the inflatable cells is distributed by controlling the filling/emptying of them according to certain pre-established calculations based on and according to the measurements made with sensors, in, on or under the mattress depending on the type of sensors utilized.

Such sensors known by persons skilled in the art can measure the pressure exerted by the patient's body or the penetration of the patient's body into the given areas of the mattress, as described for example in European patent EP 0 676 158 and European patent EP 1 056 372, as well as unpublished patent application FR 09 53758 filed on Jun. 5, 2009 describing pressure sensors including a capacitive measuring cell.

The control and regulation of the filling/emptying of the inflatable elements by means of electromagnetic valves also makes it possible to provide support devices functioning in the so-called “alternating pressure mode” in which certain inflatable cells of the support device regularly distributed over the length of the latter are alternately and simultaneously inflated and deflated. For example, one of two cells, or of three, or even of four is deflated/reinflated, and then the cells adjacent to the previously deflated then reinflated cells are deflated/reinflated.

Thus, each inflatable cell of the support device is successively deflated/reinflated from one cell to another, creating a sort of wave moving in the longitudinal direction of the device back and forth and relieving the interface pressure locally, and promoting the vascularization of the soft tissue at the interface with the surface of the support device.

At present, the support devices, specifically the mattresses, incorporating such inflatable cells include, for example, a first layer, the geometry of which is kept fixed due to the construction and which generally consists of an air mattress, the envelope of which is not elastic or of a foam layer, of a generally constant thickness throughout the length of the mattress, forming a so called lower mattress which supports a second layer, generally called a “therapeutic mattress.” The second layer is formed by juxtaposing inflatable cells, generally in the form of more or less cylindrical cells or rolls lying extended in a transverse direction perpendicular to the longitudinal direction of the mattress, welded to one another over their length or only connected to one another at their ends in the transverse direction of the mattress. Each of the areas of the therapeutic mattress is equipped with electromagnetic valves and suitable hoses capable of being connected to an inflation and regulating device, generally independent of the mattress. The lower foam mattress, when there is such and the therapeutic mattress consisting of inflatable cells are enclosed in a specially adapted slipcover to enable the filling and emptying of the inflatable cells of the mattress through hoses connected to an attached inflation and regulating device.

Such mattresses with an at least partially inflatable structure allow for the prevention, and the effective and increased treatment of bedsores and other injuries or pains associated with keeping patients in a lying and nearly immobile position on hospital beds for a prolonged time, specifically through the implementation of alternating cycles of inflation/deflation of the cells of the therapeutic mattress and use of differentiated inflation pressure of the cells according to the different support areas of the patient's body.

However, as each patient exhibits a different morphology, size, mass and pathology from those of another patient, it is desirable to further improve the comfort of inflatable cell type mattresses and, in particular, their adaptive capabilities in terms of action, support or bearing pressure provided by the mattress in the various areas of the body of the patients. This should be in accordance with physical and pathological parameters of the latter, as alluded to above and which can be subject to care instructions and protocols relating to care and the position of the patients on the mattress, particularly when changing from a lying to a seated position on the mattress, for example.

It is known to provide different areas in the mattress structure, specifically, in an area for the sacrum and in an area for the heels, including cells of different heights and/or widths between the different areas, to enhance the bearing capacity of the mattress according to the morphology and the position of the patient. Typically, an area is provided for the heels extending over a sizable distance, specifically greater than 500 mm, such that said area protects the heels of the majority of the patients according to their morphology.

In this application, “head area,” “back area,” “sacrum area,” “thigh area,” “calf area” and “heel area” of the mattress refer to the areas of the mattress supporting the corresponding anatomic regions of the body of the patient lying on the mattress.

Multiple separate individual transverse cells including the heel area as described in EP 2 005 929 exhibit a reduced longitudinal direction of the mattress in relation to the consecutive cells of the adjacent areas, particularly the leg support area, that is to say, the calf and thigh area.

The heels are very sensitive to the risk of bedsores, due to the fact that there is very little contact surface to support them due to the lever effect of the leg and also because the heels have very little muscular covering. The very low thickness of the soft tissue, being compressed on the boney spines of the heel, causing ischemia or degradation of the vascularization in the area of the capillary pole is very easily and quickly degraded or blocked, that is to say, ischemia may result in tissue necrosis and bedsores. To reduce the risk of bedsores on the heels, it is possible to generate an area inflated with a very low air pressure (around 7 mbar), so as to push in the heels as much as possible to obtain a maximum contact surface through optimum immersion into the air cushions.

All patients are positioned at the same level with the sacrum roughly in the central area of the mattress, which can be marked either by a visual mark on the mattress, a mark aligned on the prominent part of the head of the femur, or by articulating the various parts of an articulated frame, specifically the back of the chest relief raised for example to 45°, with the patient automatically sliding into the “V′ recess created in the sacrum area between the back area and the thigh area of the frame, to then return to the sought position, for example to the flat horizontal position.

Consequently, for small-size patients, the position of all the transverse cells forming the heel area of the mattress may not be able to be placed under the heels. To resolve this problem, relatively large heel areas were typically provided in the longitudinal direction of the mattress. Conversely, however, for larger than standard-sized patients, the heel area can then be extended in the longitudinal direction of the mattress up to the calf of the patient, which are no longer supported by the adjacent transverse area constituting a calf area, the cells of which have a dimension in the longitudinal direction of the mattress, different from that of the heel area, so as to give it a bearing pressure more suited to supporting the calves.

### SUMMARY

According to this disclosure, a mattress includes separate inflatable transverse cells, the length of which can be adapted upon installing a patient on said mattress in a manner that is easy to manufacture and implement, and particularly taking as a reference the position of the heels, such that they rest on an end area specifically suited to supporting them, called the “heel area” comprising transverse cells of specific dimensions without said heel area of the mattress supporting an adjacent part of the body consisting of the patient's calves.

This disclosure provides a support device, the dimension of which, in the transverse direction of the mattress, that is to say, the width of the mattress, can be modified to adapt to different bed frame or bed base widths suited to the variable morphologies of the patients while offering a continuity of therapeutic benefits extended to the edges, that is to say, the possibility of regulating the air pressure over the entire width of the mattress on the one hand, and on the other providing increased protection for the patient on the mattress.

To this end, this disclosure provides a therapeutic support device as described above, characterized in that said mattress includes at least one of the two means of adjusting the surface of the mattress selected from among:
a) means of adjusting the width of the mattress including:
   a1) at least one area of the mattress, said retractable area, consisting of a plurality of said essentially cylindrically shaped, pneumatically independent, inflatable transverse cells, preferably of 3 to 6 cells in a more or less parallelepiped shape, and
   a2) methods for grouped movement of at least one area of the mattress, said end area extending from one end of the mattress up to said retractable area, said end area consisting preferably of said inflatable transverse cell(s), said methods of grouped movement being capable of enabling a translation of said end area, optionally of all said transverse cells of said end area, to any position between at least:
an extended position from the retractable area corresponding to the position of at the longest part of the mattress, in which said end area is juxtaposed against said retractable area, all said transverse cells of said retractable area being inflated, and
a retracted position of the retractable area corresponding to the shortest part of the mattress, in which said end area is juxtaposed against said retractable area, all said transverse cells of the retractable area being deflated and juxtaposed one against the other in the longitudinal XX′ direction of the mattress, the retraction of said retractable area and juxtaposition of said transverse cells against one another resulting from said translation type movement of said end area, and
b) the means of adjustment of the width of the mattress including at least one lateral inflatable cell extending over at least one half, optionally at least two-thirds of the mattress from its head end, or even over the entire length of the mattress, laid out against a longitudinal side of the mattress, said lateral cell exhibiting a height at least equal to that of said transverse cells, said lateral inflatable cell being pneumatically independent.

Said retractable area makes it possible not only to adjust the length of the mattress, but also to utilize an end area of appropriate dimensions adapted to support only one well-determined dimensional area of the body in the well defined longitudinal direction of the mattress, specifically to utilize a reduced-size heel area supporting only said heels regardless of the length of the patient, by moving said end area after having reduced the size of said retractable area by deflating at least some of the cells of said retractable area and moving said end area by translation.

In some embodiments, the cells of the retractable area are successively juxtaposed side by side parallel to each other in the longitudinal XX′ direction of the mattress; when the cells of the retractable area are deflated and juxtaposed against one another in the longitudinal XX′ direction of the mattress, it results in the opposed transverse lateral walls of said cells of the retractable area being laid out vertically, compressed against one another; and the retractable area can be retracted only partially, the mattress adopting an intermediate dimension when only some of the cells of the retractable area are deflated, all the inflated and deflated cells of the retractable area being juxtaposed against one another.

By “pneumatically independent” it is understood that said cell can be inflated or deflated individually or separately, independently of the other cells.

Said lateral inflatable cells make it possible to adapt the width of the mattress according to whether they are inflated or deflated, said cells being inserted between the lateral edges of the mattress and those of the support plane, specifically between the barriers of the bed frame when provided and the mattress including said transverse inflatable cells positioned side by side in the longitudinal direction of the mattress.

Thus, a support device in accordance with the present disclosure makes it possible to adjust the dimensions of a mattress both in width and in length.

The means for adjusting the width of the mattress provides an increased protection for a patient against the risk of bearing against rigid lateral barriers of the bed frame or relative to the risk of entrapment in the space between the mattress and the barriers.

In addition, the means for adjusting the width of the mattress provides, when desired, protection of the patient against the risk of bearing against or contact with on the rigid lateral barriers by providing a lateral protective lining obtained by partially or completely raising said lateral cells, so that their upper surface is positioned above the upper surface of said transverse cells of the mattress, roughly perpendicularly to the latter, as will be explained herein below.

When all said transverse cells of the retractable area are inflated, said end area supports a part of the body, specifically the heel area, positioned so as to be appropriate for larger people, the reduction of the dimension of the retractable area in the longitudinal direction of the mattress making it possible to adapt the positioning of said end area, specifically of the area of the heel with respect to the corresponding area of the body of smaller patients.

Said lateral cells for adjusting the width of the mattress are positioned against the ends of said transverse cells constituting the fixed width part of said mattress.

Said lateral cells, also called “lateral cushions,” thus make it possible to adapt the width of the lying surface according to the patient and particularly to reduce such width for an optimal bearing pressure of the patient, while maintaining the same size width of the bed base or frame, or to adapt the width of the support device to the width of the support plane of the bed frame or base. They can be adapted to any type of mattress and not necessarily inflatable cell type mattresses, such as foam mattresses.

The movement by translation of said end area towards the retractable area that is adjacent to it can be done manually or in a motorized manner, particularly if the bed frame or base includes a portion, particularly a motorized movable end portion, as is known, thus making it possible to provide a bed frame or base and a variable length support plane. More specifically, said means for grouped movement of said cells of said comprises: the means for guiding the movement of said end area in the longitudinal XX′ direction and the grouped connection means for connection between the ends of a plurality of transverse cells forming said end area, said ends being located on the same side of said mattress in the transverse YY′ direction, on both sides of said mattress, said grouped connection means optionally including two lateral flexible strips extending over the side of said mattress in the longitudinal XX′ direction of said mattress and on each side of it, fastening elements located on said ends in the transverse YY′ direction of said transverse cells of said end area, and optionally of said transverse cells of said retractable area, being connected to said flexible strips.

Still more specifically, said grouped movement means include a first lower layer or lower mattress on which said cells of said end area rest and the methods of guiding the movement of said first lower mattress in the longitudinal XX′ direction of the mattress, possibly including a recessed slide-forming chamber in the lower plane surface or underside of said first lower mattress, said first lower mattress resting on said bed base or bed frame and a complementary rail capable of being guided by translation within said recessed chamber, said transverse cells of the retractable area possibly resting on said bed base or bed frame and exhibiting a height greater than that of the transverse cells of said end area.

In one variation, the size of said retractable area is reduced progressively by successive deflations of said retractable area and progressive movement of said end area until the size of said mattress is satisfactory, specifically until, if desired, the patient's heels rest on the end area consisting of a heel area.

However, optionally, said means for adjusting the length of the mattress additionally include means for automatically deflating all said transverse cells of said retractable area, then automatically reinflating only one or some of said deflated cells of said retractable area after movement by translation of said end area from said longer length position of the mattress to a desired reduced length position of the mattress, so as to reinflate only the deflated cells of the retractable area that are to be occupied after reinflating the greatest possible volume of empty residual space between said end area following movement to said desired position and the fixed end of the retractable area located on the opposite side to that adjacent to said end area.

Optionally, said transverse cells of the retractable area include internal welded type connections or possibly braces positioned in parallel, horizontally or vertically, providing a connection between the opposed faces of said transverse cells and compartments communicating pneumatically between each other at their ends in said transverse YY′ direction with horizontal internal connection means and communicating pneumatically to their ends in the vertical ZZ′ direction with vertically internal connection means.

Because said welds or braces do not extend over the entire length of said cell in the transverse YY′ direction or respectively over the entire height of said cell in the vertical ZZ′ direction and possibly do not reach up to each of the two opposed lateral faces of said cell for said horizontal connection means or respectively do not reach up to each of the two upper and lower faces of said cell for said vertical internal means of connection, said cell includes a single air feed and evacuation orifice.

In this application, by “brace” it is understood that the flexible elements potentially include a material made solid in a substantially airtight manner with the material of the envelope including the faces of the cell, specifically the parallelepiped faces of said cells, the geometry of which is fixed, for example of weldable polyurethane-coated cloth, two opposite edges of said braces being joined with two opposite faces of said cell, specifically two opposite vertical transverse lateral faces of said cell, these being the cells of said retractable area or two upper and lower horizontal faces of said cell, which are the cells of said head area, back area, calf area and thigh area, as described herein below.

In some contemplated embodiments, said end area is the heel area on which the heels of a patient lying on said mattress can rest, said heel area possibly including three to eight, including six in some embodiments, pneumatically independent transverse cells and located downstream of said retractable area, this latter including three to six said transverse cells, possibly four cells, laid out just upstream of said heel area, said heel area extending in the longitudinal XX′ direction of the mattress over a length of 100 to 400 mm, possibly 150 to 300 mm, and said retractable area when fully inflated extending over a maximum length in the longitudinal direction from 100 to 400 mm, possibly 150 to 300 mm, said transverse cells of said heel area and said retractable area, in some instances, being mechanically independent of one another.

By “mechanically independent” it is understood that said transverse cells can be individually separated from said area, that is to say withdrawn or added into said area individually, optionally said transverse cells being assembled against one another successively in the longitudinal direction by the sole fact of their connection at their ends in the transverse direction to said upper lateral maintenance strips.

In one embodiment, said retractable area comprises four cells, of which two are side by side and capable of being deflated and reinflated by the same fluid transfer hoses, the two other cells of said retractable area being independently inflatable and reinflatable. However, optionally, all the cells of the retractable area are pneumatically independent.

In some embodiments, said mattress includes certain areas, such as the head area, the back area and the thigh area each comprising a single cell extending in the longitudinal direction of the mattress over a distance equal to several times the dimension of a transverse cell, of an adjacent area, possibly of the sacrum area and of the heel or retractable area, said cell of larger dimension in the longitudinal XX′ direction of the mattress being compartmentalized by welds or transverse braces possioned vertically and forming compartments communicating at their ends in the transverse direction of the mattress.

Said larger dimension cells in the longitudinal direction of the mattress, such as the cells of the head area, of the back area and possibly of the leg area are on the whole less expensive to produce, as they result from a connection with the other of two upper and lower faces of the cell on its peripheral circumference with said braces. These areas of a single cell are utilized more specifically around areas less susceptible to the appearance of bedsores and for which the interface has not been optimized by a greater number of separate smaller transverse cells in said longitudinal direction of the mattress, as is the case for the sacrum area and the heel area.

The mechanically separated transverse cells, specifically of the sacrum and heel area, of smaller size in the longitudinal direction of the mattress also make it possible to utilize the processes of alternating inflation of the various successive cells, making it possible to reduce the contact surface of the concerned area of the body with the mattress. However, these alternating inflation processes may not be required for certain areas favoring the development of bedsores, such as the back area and the leg area. With respect to the head area, it is known that a process of alternately inflating the different consecutive transverse cells of said area can induce a certain discomfort due to the fact that the head exhibits a relatively small bearing surface in the longitudinal direction of the mattress, which, in practice, would not exceed the size of an individual reduced-size transverse cell, in the event that a plurality of said separate reduced-size transverse cells were utilized in the longitudinal direction of the mattress for said head area.

This present disclosure likewise provides a method for adjusting the size of a support device, comprising:
a) the length of the mattress is modified by partial deflation, optionally completely deflating said transverse cells of said retractable area, then moving said end area by translation, then optionally respectively partially reinflating said retractable area so as to reinflate only the deflated cells of the retractable area needed for occupying the largest possible volume after reinflation of the residual empty space between said partially or completely deflated retractable area and said end area after movement of the latter to said desired position, and/or;
b) the width of the support device is modified by inflation or deflation of at least one said lateral cell.

More specifically, the length of the mattress is modified from a maximum length position in which all the transverse cells of a retractable area are inflated and by following all the successive steps in which:
1) all the transverse cells of the of the retractable area are deflated, and
2) said end area is moved up to a said desired position in which said heel area supports the heels without contacting the calves of the patient, said retractable area being positioned with respect to the base of the patient's calves, and
3) the cells of the retractable area located between the fixed end upstream of the retractable area and said heel area following their movement to said desired position are reinflated.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 depicts a view of a support device according to the present disclosure with a mattress comprising a retractable area and lateral cushions in a lowered position (on a bed frame adapted for medical use with barriers in perspective view).

FIG. 2 is a perspective view of a mattress including two lateral cushions 2a, 2b on its two opposed lateral edges.

FIG. 3 depicts the support device of FIG. 2 with different areas of the inclined mattress in relation to each other resulting from the articulation of a bed frame 11, the support device being covered by a slipcover 40, the right part of which is not shown in order to reveal the shape of lateral cushion 2a following folding of the support device following an articulation of the bed frame.

FIG. 4 depicts support device 10 in which lateral cushions 2a, 2b are in a raised position and protected by a pocket 40a of slipcover 40.

FIG. 5 is a side view in the longitudinal XX′ direction of a lateral cushion 2a, 2b, according to the present disclosure.

FIGS. 5A and 5B are detailed views of the air space areas 3-1 (FIG. 5a) and 3-2 (FIG. 5B) of FIG. 5.

FIG. 5C is a median longitudinal sectional view from above AA, lateral cushions of FIG. 5.

FIG. 5D is a side view in the transverse YY′ direction of lateral cushion of FIG. 5.

FIG. 6 is a perspective view of support device 10, the upper mattress of which comprises a plurality of areas of inflatable transverse cells, including a head area and a retractable area according to the present disclosure.

FIGS. 7A and 7B depict detailed views of a guide rail enabling the guiding of the movement of the heel area engaging with a recessed jacket on the underside of the lower mattress supporting the heel area of the support device of FIG. 6.

FIGS. 8A, 8B and 8C depict a lateral retaining and fastening strip of the different transverse cells constituting the different areas of the mattress of FIG. 6, as well as a distribution bus of the various air feed and evacuation hoses.

FIGS. 9A, 9B, 9C, 9D and 9E depict the schematic views of the various possible configurations of retractable area 8, adjacent to a heel area 9 in long configuration (FIG. 9A), with a retracted cell (FIG. 9B), two retracted cells (FIG. 9C), three retracted cells (FIG. 9D) and four retracted cells (FIG. 9E).

FIG. 10 depicts a perspective view of a transverse cushion of said retractable area.

FIG. 10A depicts a side view showing a lateral face of the transverse cell of FIG. 10.

FIG. 10B depicts a view from above the transverse cell of FIG. 10.

FIG. 10C depicts a side view showing the lateral end face in the transverse direction of the transverse cell of FIG. 10.

FIG. 11 is a schematic view of the principle of electronic wiring of the air feed and evacuation circuit of the retractable area.

FIG. 12 is a view of a head area cushion of a single cell.

FIG. 12A is a view from above of the cushion of FIG. 12.

FIG. 12B is a sectional side view according to BB of FIG. 12A.

FIG. 13 is a view of a head area consisting of three cushions laid out side by side in the transverse YY′ direction of the mattress.

FIG. 14 is a perspective view of a patient resting on a support device according to the present disclosure with a head area with three compartments, including a deflated lateral cushion and the retractable area of which is retracted with only two inflated transverse cushions, so that the heel area supports the heels just following the overall detachment between the retractable area and the heel area of the mattress on the one hand and on the other the calves are supported by a calf support area, of which the configuration of the constituting transverse cells is different from that of the heels and of the retractable area.

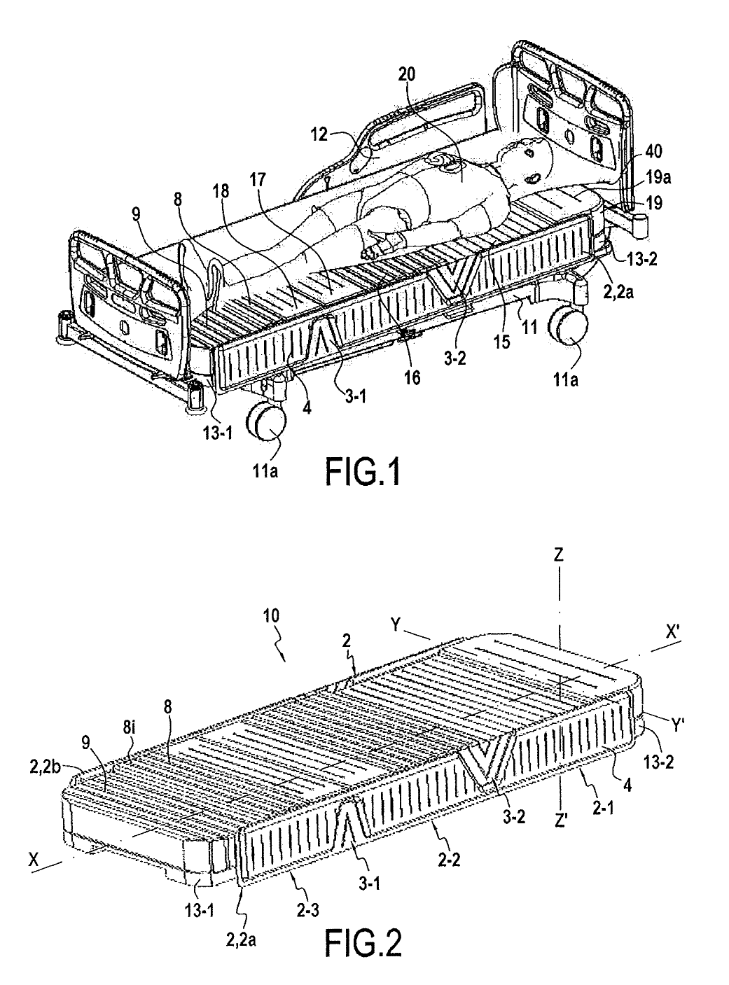

### DETAILED DESCRIPTION

A support device 10 according to the present disclosure as depicted in the Figs. includes a mattress consisting of a plurality of inflatable transverse cells extending in the transverse YY′ direction perpendicular to the longitudinal XX′ direction of the mattress. These different inflatable transverse cells are grouped to form an area of the mattress for supporting a particular part of the body as defined herein below. Some of the areas of the mattress are supported by a lower mattress 13-1, 13-2 resting on a frame 11.

Such areas of the mattress more specifically include, from upstream to downstream successively in said longitudinal XX′ direction: a head area 19, as defined herein below; a back area 15 comprising a single transverse cell divided into several compartments 15i, i=1 to 11, by braces or welds 15a extending into said transverse YY′ direction and providing a connection between the upper and lower faces of said cell, possibly 5 to 15 braces or welds, such as 10, said compartments 15i communicating with their ends in the transverse YY′ direction, because said welds or braces 15a do not extend over the entire length of said cell in said transverse YY′ direction and optionally do not reach up to each of the two lateral edges of said cell; a sacrum area 16 including a plurality, such as 5 to 10, pneumatically independent, optionally mechanically independent, transverse cells 16i, where i=5 to 10, said cells (16i) including mechanically reversible fastening methods 23 with two lateral flexible maintenance strips 22a, 22b extending the length of said mattress 1 in said longitudinal XX′ direction respectively from the two sides; a thigh area 17 including a single transverse cell partitioned into several compartments 17i, where i=2 to 5, such as 3, by braces or welds 17a, extending in said transverse YY′ direction and providing a connection between the upper and lower faces of said cell, possibly five to fifteen braces or welds, such as ten, said compartments 17i communicating with their ends in the transverse YY′ direction of the mattress, because said welds or braces 17a do not extend over the entire length of said cell in said transverse YY′ direction and optionally do not reach up to each of the two lateral edges of said cell, and a calf area 18 including a single transverse cell partitioned into several compartments 18i, where i=2 to 5, such as three, by braces or welds 18a, extending in said transverse YY′ direction and providing a connection between the upper and lower faces of said cell, possibly 5 to 15 braces or welds, such as 10, said compartments 18i communicating with their ends in the transverse YY′ direction of the mattress, because said welds or braces 18a do not extend over the entire length of said cell in said transverse YY′ direction and optionally do not reach up to each of the two lateral edges of said cell, the cell of said calf area 18 resting on a service unit 14, itself resting on said bed base or bed frame 11; a retractable area 8, including three to six transverse cells 8-1 to 8-4, such as four, pneumatically independent and possibly mechanically independent, said cells 8i including the methods of reversible mechanical fastening 23 to two said lateral flexible maintenance strips 22a, 22b, said transverse cells 8-1, 8-4, of the retractable area resting directly on bed frame 11; and an end area or heel area 9 resting optionally on said first lower mattress 13-1, and possibly made of synthetic foam.

Said heel area including possibly 3 to 8, such as 6, pneumatically independent transverse cells 9-1 to 9-6 resting optionally on a first lower mattress 13-1. The cells of said head area, back area, sacrum area, and thigh area resting on a second lower mattress 13-2 possibly including a single inflatable cell. At least said cells of the sacrum area and of the heel area, but possibly all the areas of the mattress, are filled with air, the pressure of which is regulated at the same said air pressure by utilizing said means for regulating the air pressure within the cells. The upper surface of all the inflatable cells of the mattress roughly reaching the same height to constitute a horizontal support plane with the exception of cells 9i of said heel area 9, the upper surface of which is lower to create a said detachment reducing the interface pressure on the underside of the heel.

Support device 10 according to the present disclosure comprises a service unit 14 enclosing the inflation means, such as a pump, electronic means of regulating the pressure inside the cells, electronic means of controlling the various valves opening and closing the air feed and evacuation orifices of said various pneumatically independent cells, and the means for controlling a retraction function making it possible to control the complete deflation of all the cells of said retractable area, then the reinflation of only a part of said cells of said retractable area following movement of said end area to a said desired position as described herein below.

In a first embodiment, said mattress 10 comprises a head area 19 carrying a single pneumatically independent cell, possibly partitioned into several compartments, specifically three compartments 19-4, 19-5, 19-6, by connection means consisting optionally of transverse and vertical braces 19a providing a connection between the upper faces 19b and lower faces 19c of said cell, optionally two said braces 19a, said compartments 19-4, 19-5, 19-6 communicating with their ends in the transverse YY′ direction, because said welds or braces 19a do not extend over the entire length of said cell 19 in said transverse direction and therefore, do not reach up to each of the two opposed lateral edges of said cell, said cell including a single air feed or evacuation orifice 19c.

In some embodiments, said methods of internal connection, specifically said braces are laid out in parallel between one another and the head area extends into the longitudinal direction of the mattress, over a distance equal to the distance covered by several pneumatically and, in some instances, mechanically independent transverse cells, of said retractable areas, sacrum area or end area, such as the heel area, the width of a compartment roughly corresponding to that of said transverse cells independent of other areas of the mattress

Said means of internal connection delimiting the compartments positioned in parallel side by side in the longitudinal direction of the mattress, said compartments communicating at their ends in said transverse direction, give to said cell of said head area a greater surface geometry, better adapted to the morphology of the head area in order to facilitate a desired head area bearing pressure, with the relatively level and parallel upper and lower surfaces.

The braces extending vertically between the upper face and lower face of the cushion form in longitudinal section an upper surface, the inflated curvature of which between two braces is less prominent than the curvature defined by two completely separate, mechanically individual transverse cells which makes it possible to stretch the external envelope of the cell, so as to create a more level surface than with separate cells. With separate cells, more pronounced curves and voids are produced. This is the reason why it is desirable in some embodiments to utilize braces rather than a heat seal to produce the direct connection of the two upper and lower faces of said cell of the head area. Conversely, the welds between two opposite faces would result in creating curves identical to the juxtaposition of separate cushions.

However, in some embodiments the mattress comprises a head area consisting of three pneumatically independent cells 19-1, 19-2, 19-3 each including an air feed and evacuation orifice 19d positioned side by side in said transverse YY′ direction, optionally each said cell 19-1, 19-2, 19-3 being compartmentalized by welds or braces 19a, with the connection between their upper face 19b and lower face 19c, said welds or braces extending possibly into said transverse YY′ direction and not reaching up to the ends 19-7, 19-8 of said cells in said transverse YY′ direction, so as to partition said cells 19-1, 19-2, 19-3 into compartments 19-4a, 19-5a, 19-6a pneumatically communicating between them in the area of said ends 19-7, 19-8.

Thus, the comprised head support area of a central cell 19-2 and two lateral cells 19-1 and 19-3 positioned on each side of the central cell in said transverse direction is designed in order to make it possible to provide care requiring easy access to the head, by deflating one of the lateral cells, the head remaining supported by at least the central cell. The deflating of one of the lateral cells specifically facilitates intubation in the area of the patient's throat after pivoting his/her head resting on the central cell, pivoting in the direction of the deflated lateral cell. Optionally, the height h2 of the head cell 19, shown in FIG. 12B, is greater than height h, see FIG. 14, of the adjacent cells 15, 16, and in some embodiments, h2=17 cm and h=13 cm.

The cushions of the head area are fixed to lateral maintenance strips by lugs 19g, 23.

The various individual cells comprising the head area, the back area, the thigh area, the calf area, as well as the various individual transverse cells of sacrum area 16i of retractable area 8i and of heel area 9i can be produced in the following manner.

Evacuation orifices 19d of the cushions of the head area make a selective deflation possible of lateral cells 19-1 and 19-3 in order to facilitate lateral decubitus of a patient and the passage of a tube toward the patient's head. The deflation can be done by manual quick-release coupler connections with a non-return valve accessible on the upper face. In the illustrative example, the feed of the head area is done directly from the central area via a quick-release coupler with a non-return valve on the back area, which makes it possible to exhaust the head area very quickly.

The heat sealing of the two sheets of plastic material, in some instances of PVC or polyurethane or of cloth coated with such plastic material, heat sealed one against the other or else the same sheet folded on itself and the two superimposed parts of which are also heat sealed one against the other according to different welding lines making it possible to form the peripheral circumference of said area or said individual transverse cell as well as the means of internal connection providing the connection between the upper face and the lower face of said cells.

In some embodiments where braces are used as the means of internal connection between the upper faces and the lower faces of the cells, the upper and lower edges of said braces are heat sealed in advance onto said upper and lower faces of the cells prior to performing the heat sealing of the peripheral circumference of the cell.

The various small-width individualized inflatable transverse cells in the longitudinal direction of the mattress comprising the sacrum area, retractable area and heel area, as well as the single large cells forming the head area, back area, calf area and thigh area, comprising lateral orifices at their ends in the transverse YY′ direction enable the air feeding and evacuation by a distribution bus positioned on the longitudinal sides of the mattress, extending from service unit 14 which contains the pump and the electronic control means, as well as the electromagnetic valves controlling the opening and closing of said air feed and evacuation orifices.

The retractable area cooperates with the inflation and deflation means of the various pneumatically independent cells contained in service unit 14, which specifically include a retraction function, which controls the automatic deflation of all the small transverse cells 8-1 to 8-4 of said retractable area 8, then automatic reinflation of only one part of said inflated cells closest to said calf area 18, that is to say, fixed end 8a of the retractable area 8, following movement by translation of heel area 9 by means of grouped movement up to a reduced size position of the retractable area 8 from the initial position in which all said transverse cells of the retractable area 8 were inflated.

Said means for grouped movement of said cells of heel area 9 include:
grouped connection means 22a-22b, 23, ensuring the connection of the ends of a plurality of transverse cells 9-1, 9-6 comprising said end area 9, said ends being located on the same side of said mattress in the transverse direction (YY′), likewise for both sides of said mattress, said grouped connection means comprising two lateral flexible strips 22, 22a-22b extending onto the side of said mattress in the longitudinal XX′ direction of said mattress and each side of it, said flexible strips to which are fastened, fastening elements 23 located on said ends in the transverse YY′ direction of said transverse cells of said end area 9 and optionally of said transverse cells 8-1, 8-4 of said retractable area, and
guidance means 13-1, 21a-21b, 22a-22b for the movement of said end area 9 in said longitudinal XX′ direction comprising guidance means 21a, 21b for the movement of first lower mattress 13-1 on which transverse cells 9-1, 9-6 of the heel area rest, such means of guidance including a slide-forming recessed jacket 21a or housing constituting the underside of said first mattress and a rail 21b of complementarily shape capable of being guided by translation to the inside of said slide 21a, said rail 21b being joined to the level base or frame 11 on which said first lower mattress 13-1 rests.

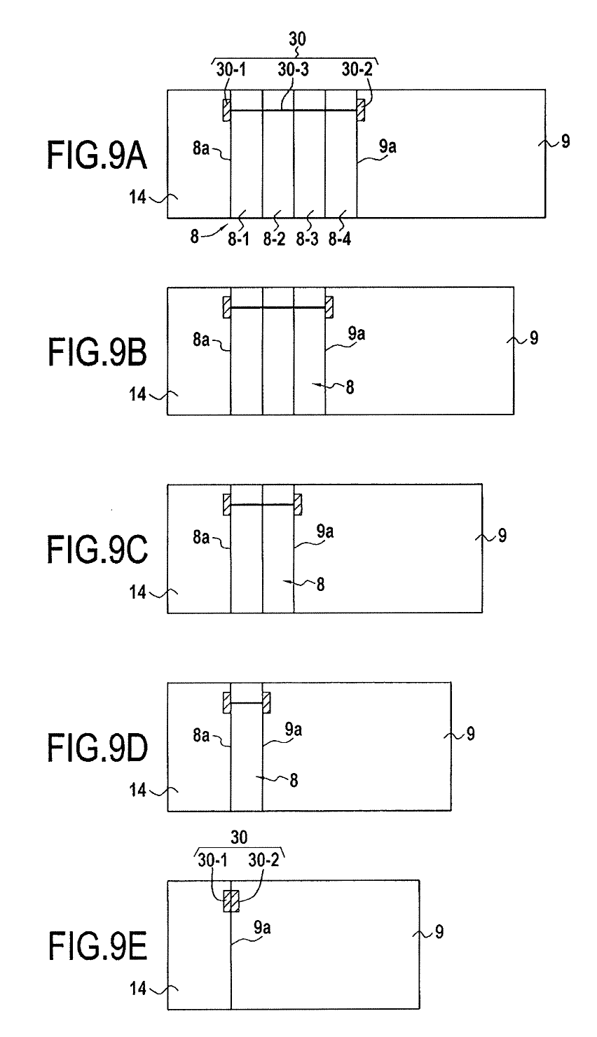

Thus, after complete deflation of the four cells of said retractable area, the heel area is moved to a desired position according to one of the four retracted positions with a single retracted cushion as depicted in FIG. 9B, with the three cushions closest to the inflated service unit and cushion 8-4 on the side of end 9a of deflated heel area 9. In the other retraction positions of FIGS. 9C, 9D and 9E, it is two, one and zero cushions that are respectively inflated and two, three and four cushions, respectively, that are deflated.

In some embodiments, said automatic means of reinflation of a limited number of said transverse cells of said retractable area 8 comprises a device for measuring the distance between said end area after its movement to said desired position and the opposite fixed end of said retractable area and the electronic means of calculating the number of deflated cells of said retractable area to be reinflated from said fixed end of said retractable area, according to the distance measured by said measurement device.

In some embodiments, said distance measurement device comprises:
a wave transmitter 30-1, possibly transmitting an infrared or ultrasonic type wave 30-3, said transmitter being installed on a fixed part of the mattress, optionally in the area of said fixed end of the retractable area, and
a receiver 30-2 reflecting to said transmitter, an undulated signal issued by said transmitter, said receiver being fixed to said end area 9, possbily at the end of the latter adjacent to said retractable area 8.

In a known manner, said distance can be deduced by measuring the round-trip time of the signal from said transmitter and/or by analysis of the differences in phases between the transmitted signal and the received signal.

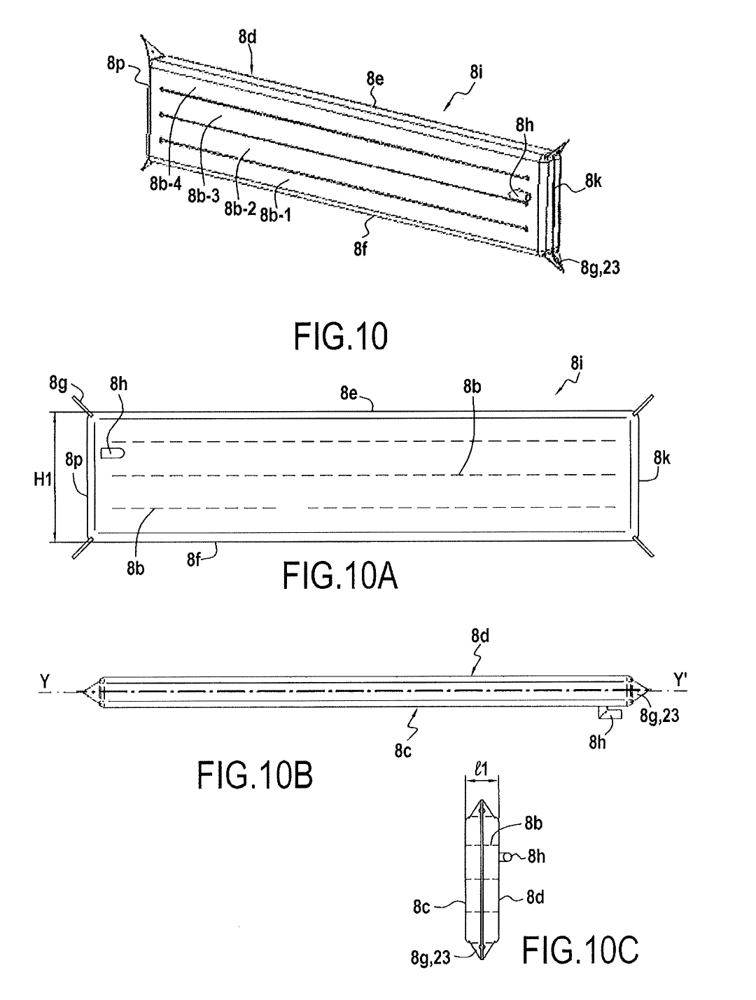

Optionally, said cells of said retractable area 8 have a dimension L1, as shown in FIG. 10C, in the longitudinal XX′ direction less than or equal to that of the cells of said end area 9 and, in some instances, less than that of the other inflatable transverse cells constituting said mattress, for example, L1=50 mm.

Such reduced width of the cells of the retractable area and the relatively low number of three to six, possibly four, of the retractable cells makes it possible to obtain a progressive variation of the size of the retractable area 8, without being hindered by the stacking of the vertical lateral walls of the deflated cells juxtaposed against one another, which are typically not compressible. The plurality of the transverse cells of said retractable area 8 makes it possible to better control and adjusts the size of the retractable area 8 according to the number of cells kept deflated. However, an excessive number of cells in the retractable area 8 would possibly lead to an incompressible stacking of excessive size, increasing the dimension of the completely deflated retractable area and thus limiting the possible movement of the adjacent end area 9. Thus, a number of four said retractable area 9 transverse cells is chosen in the illustrative embodiment to fill a void of 15 to 25 cm, including 20 cm, with each cell representing an approximate distance of 5 cm in the longitudinal direction of the mattress.

In the illustrative example, said cells of the retractable area 8 exhibit a height H₁ greater than that h of the other said transverse cells comprising said mattress, for example, H1=200 mm and h=130 mm.

This characteristic makes it possible to have said transverse cells of the retractable area 8 rest directly on the bed base or bed frame 11, while the other transverse cells of the adjacent areas rest either on a lower mattress 13-2, or on a service unit 14, as will be explained herein below.

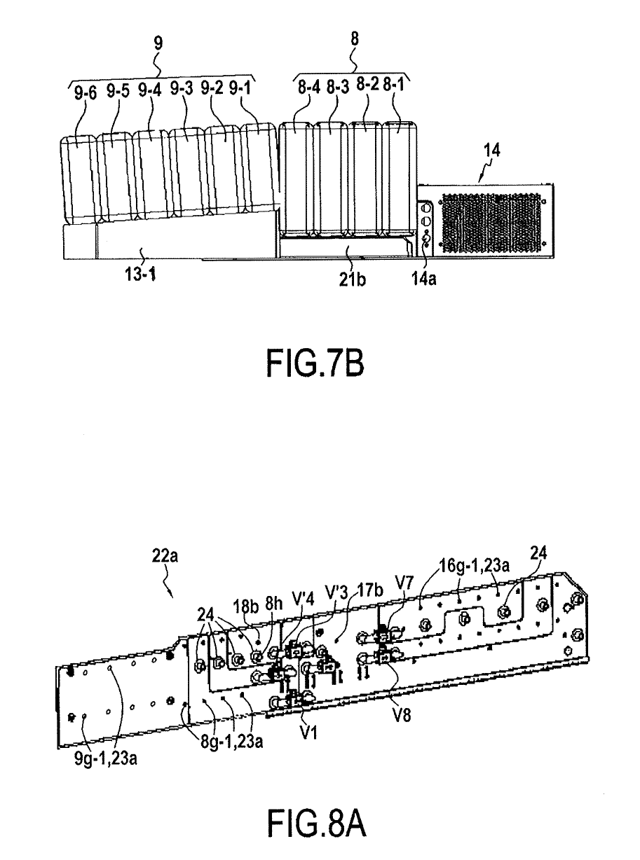

In the embodiment of FIG. 7A, cells 8-1 to 8-4 of the retractable area 8 rest directly on guide rail 21b itself joined to bed base or bed frame 11. In this case, the height of the retractable cells 8-1 to 8-4 can be limited to 18 cm, if guide rail 21b represents a height of 2 cm. In FIG. 7A, the height of guide rail 21b is accentuated to better depict the configuration of the guidance system.

In some embodiments, said transverse cells of the retractable area 8 comprise means of internal connection 8b possibly including at least two, optionally at least three braces laid out horizontally in parallel, providing the connection between the vertical opposed transverse lateral faces 8c, 8d of said transverse cells and delimiting the superimposed compartments 8b-1, 8b-2, 8b-3, 8b-4 communicating pneumatically between one another at their ends 8k, 8p in said transverse YY′ direction of said horizontal means of internal connection 8b. Because said braces 8b do not extend over the entire length of said cell in the transverse YY′ direction and optionally do not reach each of the two opposed lateral faces 8k, 8p of said cell in the longitudinal XX′ direction of the mattress, said cell includes a single air feed and evacuation orifice 8h.

This division into several compartments by way of said means of internal connection of the cells of the retractable area make it possible to maintain said opposed transverse lateral faces of said cells in a vertical position even in the deflated state, thus enabling better control of the geometry of said deflated cells by reducing their volume as much as possible once they are retracted and juxtaposed against one another at the time of the retraction of said retractable area 8.

In fact, said means of connection make it possible for the cells to provide a practically constant geometry and moreover the more numerous and closer said means of connection, the more said opposed lateral faces are level. Nevertheless, a too substantial number of said connection means could stiffen the cell and increase its incompressible volume in the deflated state, that is to say increase the volume of the retractable area 8 in its minimum sized position.

Transverse cells 8-1, 8-4 of the retractable area 8 are connected to lateral maintenance strips 22a, 22b by fastening lugs 8g, 23 provided on their ends in the transverse direction, in the area of the upper face 8f and lower face 8e of said cells. These lugs 8g, like all the fastening lugs 23 of the various transverse cells include a fold of welded material forming a triangle and pierced by a hole, capable of receiving a plastic attachment joined to the lateral maintenance strip.

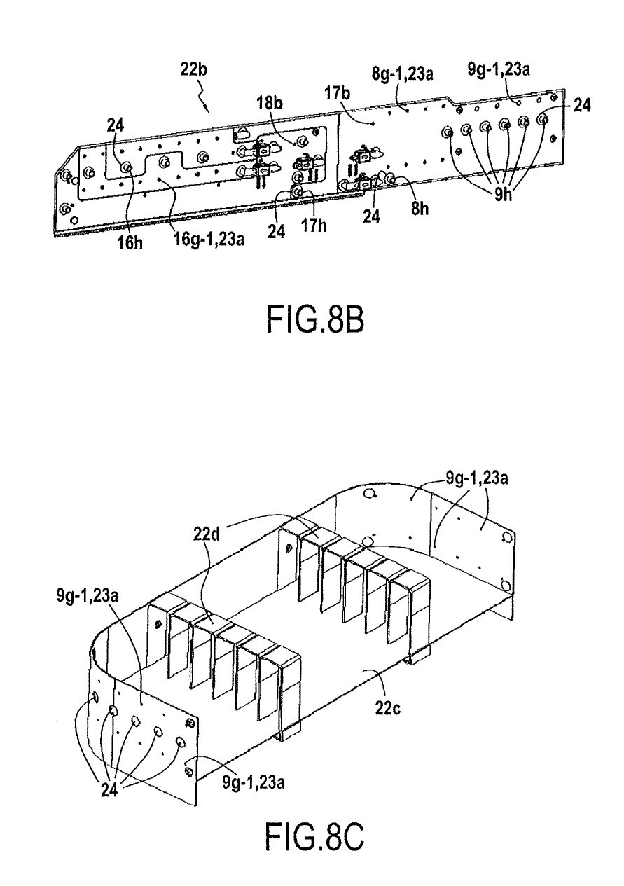

FIGS. 8A and 8B depict a part of the right lateral maintenance strip 22a (FIG. 8A) and a part of the left lateral belt 22b (FIG. 8B). Such lateral maintenance strips 22a and 22b extend the entire length of the mattress 10, but are depicted in FIGS. 8A and 8B at their downstream end, enabling the fastening of the cells of the heel area 9, retractable area 8, calf area 18, thigh area 17 and sacrum area 16.

These lateral maintenance strips 22a, 22b of flexible plastic material include holes 23a cooperating with fastening lugs 23 on the ends of the various transverse cells by means of rivets (not shown) to achieve the fastening of the various transverse cells to their ends in the transverse YY′ direction. In the illustrative example, orifices 9g-1 are depicted around heel area 9, orifices 8g-1 around retractable area 8, orifices 16g-1 around sacrum area 16 and orifices 18b and 17b around calf 18 and thigh 17 areas.

Each lateral maintenance strip comprises 24 holes capable of receiving tubular air feed or evacuation orifices 8h, 9h, 16h, 17h and 18h of the various cells of said heel areas 9, retractable area 8, calf area 17, thigh area 18, sacrum area 16.

FIG. 8C depicts a lower base 22c and the fastening clips 22d making it possible to complete the grouped connection between them of the various cells 9-1 to 9-6 of heel area 9. Clips 22d are joined to the lower base 22c and enable completion of the connection of individualized cells 9-1 to 9-16 with mattress 10. Similar lower base 22c and fastening clips 22d are provided for cells 16i of sacrum area 16. The edges of said lower base 22c are joined to said lateral maintenance strips 22a, 22b at their downstream ends. Said lower base 22c rests on the upper face of the downstream lower mattress 13-1. The fastening clips 22d enable the maintaining of the cells of the heel area in a more or less fixed position in relation to said lower base thus facilitating the movements of the heel area by grouped connection of these various cells. Conversely, cells 8-1 to 8-4 of retractable area 8 do not have such fastening clips 22d.

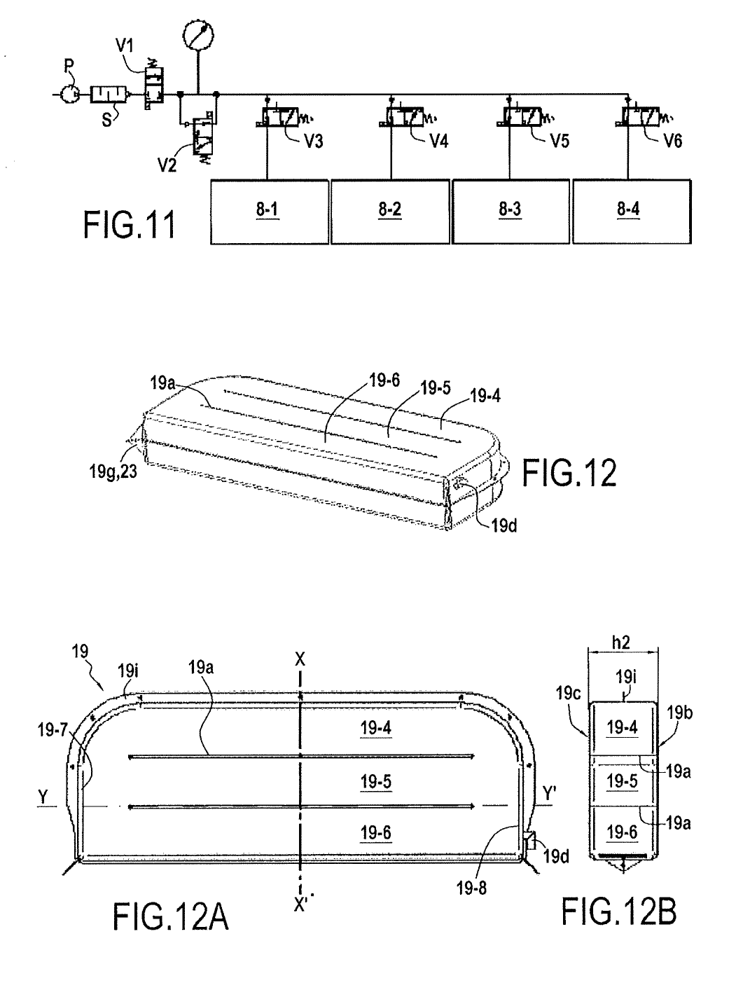

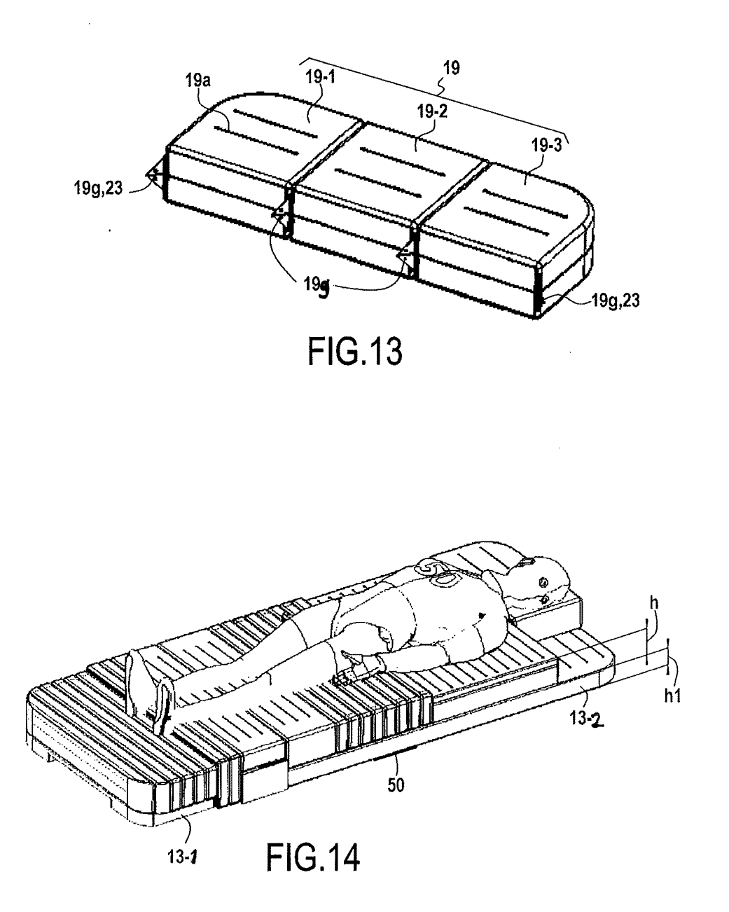

FIG. 11 shows that pump P contained in service unit 14 enables the pressurized feeding of the various 4 cushions 8-1, 8-2, 8-3, 8-4 of retractable area 8, with muffler S limiting the noise emitted by the pump for the patient's comfort. Electromagnetic valves V1 to V6 are contained in the service unit. Valve V1 enables the feeding of the retractable area as a whole. To partially reinflate the retractable area 8, as mentioned above, the electronic control means enables the opening of the number of emptying valves of the cushions 8-1, 8-4 to keep them deflated and feed valve V1 is opened, emptying valve V2 being closed.

This retractable area 8 enables the movement of heel area 9 without changing its dimensions to position it precisely under the heels of the patient lying on the mattress according to his/her size. A variable dimension retractable area 8 is inserted between dimensionally reduced fixed calf area 18 and heel area 9. Following retraction to the desired position, retractable area 8 supports the low area of the patient's calves as a complement to the fixed calf area 18.

Heel area 9 can be moved either manually by the attending personnel, or in a motorized manner. The movement by manual translation of heel area 9 can be done simply by pushing or pulling the rear end of first lower mattress 13-1 with guide rail 21b. In the case of motorized positioning, first lower mattress 13-1 will be joined with the upstream part of a bed frame 11 of a motorized device for retraction/lengthening of said bed frame 11.

The beds adapted for medical use with motorized frames can vary in length either from 2.10 m to 1.80 m, or from 2.20 m to 2 m. It is thus desirable, in some embodiments, to be able to move heel area 9 either from 30 cm or 20 cm. Thus, the inflated retractable area is entirely inflated for a maximum mattress length of 2.20 and the retractable area is deflated completely for a length of 2 m in some embodiments. To obtain a progressive variation of this dimension by 20 cm, to adjust the position of the heel area, the division into four cushions 8-1 to 8-4 of 5 cm each offers a possible selection of sufficient sizes by 5 cm steps. A 30 cm long heel area having six cells 9-1-9-6, each 5 cm wide, which can be moved up to 20 cm by complete retraction of the retractable area 8 makes it possible to handle patients from 1.50 m to 1.90 m, that is, a very large part of the patient population.

In some of the above-described embodiments, the various cells 8-1 to 8-4 of the retractable area 8 are pneumatically independent of their air feed and their air emptying, which is done independently by an air connector and tube connected to a peripheral feed bus joined to or combined with the lateral maintenance strip, resulting in lateral maintenance strip 22a-22b serving a distribution bus in some embodiments.

However, in another embodiment, in order to economize on the means for supplying of cells 8-1, 8-4, two will be fed independently and the other two by coupling their feed so as to feed by combination, a cell, two cells (one pair configuration), three cells (configuration one plus a pair) or four cells (configuration one+one+a pair). The retractable area thus comprises four cells, two of which are side by side capable of being deflated and reinflated by the same electromagnetic valve V′3 and the same fluid transfer hoses, the two other cells of said retractable area being inflatable and reinflatable independently by means of electromagnetic valve V′4.

In the above-described embodiments, heel area 9 is moved to position it under the patient's heels. However, a movement of any other area of the mattress can be permitted or created, by producing a void or reducing the area to be moved. Likewise, the retractable area can be created either upstream or downstream of the area to be shifted. It is also possible to consider utilizing two retractable areas, one before and the other after the area to be shifted.

Consequently, more generally, the movement of any area whatever can be done by moving the position of such area by inflating or deflating a retractable area in front and/or behind the area to be moved. Such area to be moved can be joined to a service unit, the movement of the area for the purpose of making the positioning of the service unit compatible with the sectioning of the support plane of the bed frame.

The various cells of the retractable area are not necessarily mechanically independent and can be joined to one another over their entire length. Cells 8-1-8-4 of the retractable area can be fed continuously at a constant pressure or alternately by sequential inflating and deflating of the cells or if one so wishes, a sequential inflation/deflation of the mattress alternately as is known in the art.

One could likewise consider moving the sacrum area by elongation-retraction of an adjacent retractable area so as to move the sacrum area according to the movement of a part of the adjustable backrest that would be capable of being moved by translation on the bed frame.

In one embodiment, the inflated cells of said retractable area 8 are higher than said cells of heel area 9, these latter resting optionally on a first lower mattress 13-2, said lower mattress 13-2 being possibly made of foam and also possibly including a recessed jacket 21a or housing forming an underside slide, capable of providing said guide means, the height difference between the upper surface of the cells of said retractable area and the upper surface of said heel area creating a step corresponding to the anatomic shifting of 2 to 5 cm between the lower rear face of the heel resting on said heel area and the lower face of the base of the calf resting on said retractable area and/or said calf area upstream of said retractable area. This step makes it possible to reduce the underside pressure of the heel exerted by the upper surfaces of the cells of said heel area and to provide a heel relief by suspension of said heels.

In another variant, the lower foam mattress 13-1 is a trapezoidal (or triangular) section, so as to generate an inclined plane in place of a 2 cm shift as depicted in FIG. 7B in which the upper surface of the lower mattress 13-1 is inclined from upstream to downstream with a progressive reduction of its height, so as to create a trapezoidal section in longitudinal vertical section of said lower mattress 13-1.

The mattress comprises as a means for adjustment of its width, two lateral cells 2a, 2b respectively positioned on each longitudinal side of the mattress.

In some embodiments, each cell 2a, 2b comprises a plurality of internal connection means 4 comprising welds or vertical braces providing a connection between the opposed lateral faces 2c, 2d of each said cell 2a, 2b, said internal connection means 4 including optionally welds or vertical braces extending over only a part of the height of said lateral cell, and in some instances, said internal connection means 4 comprising welds or braces being positioned in parallel to one another and side by side in the longitudinal XX′ direction of said cell and said internal means of connection 4 making it possible to compartmentalize said cell, into different compartments 4-1 communicating pneumatically among one another at their ends 4-2, because said means of internal connection do not extend over the height of said cell.

It is understood that as each said cell 2a, 2b is pneumatically independent, it can be fed by means of a single inflating/deflating orifice or opening 5.

Such means of connection and such vertical compartments of said lateral cell make it possible to provide compressibility of said cell with in addition a homogeneous distribution of the air over the entire length of said cell to better control the thickness (or width), that is to say its dimension in the transverse direction and also to better distribute the air over the entire height of the cell and more generally to ensure a better vertical behavior of said cell. A force on the upper part of the cell 2a, 2b causes an increase in pressure therein and stiffens compartments 4-1, 4-2, which thus oppose an untimely leaving of the bed or an accidental tilting of the patient.

It is understood that the opposed lateral faces of each said cell 2a, 2b correspond to an interior face on the side of the longitudinal end of said transverse cells of the mattress and an external face.

Said internal means of fastening 4 of weld or brace type positioned vertically also enable said cell, once deflated, to retain its vertical firmness, thus preventing it from falling flat and not filling the empty space between the barrier or the edge of the frame and the end of the transverse cells. Such internal fastening means 4 thus make it possible for said cells 2a, 2b to retain a practically constant geometry. The more numerous and closer said fastening means, the more said opposed lateral surfaces of said cells remain level. In practice, it is believed that vertical fastening means 4 should be spaced every d=15 to 50 mm to obtain a suitable cost/stability ratio of the geometry. Actually, an excessively large number of braces may cause an excessive stiffening of the inflated longitudinal cell.

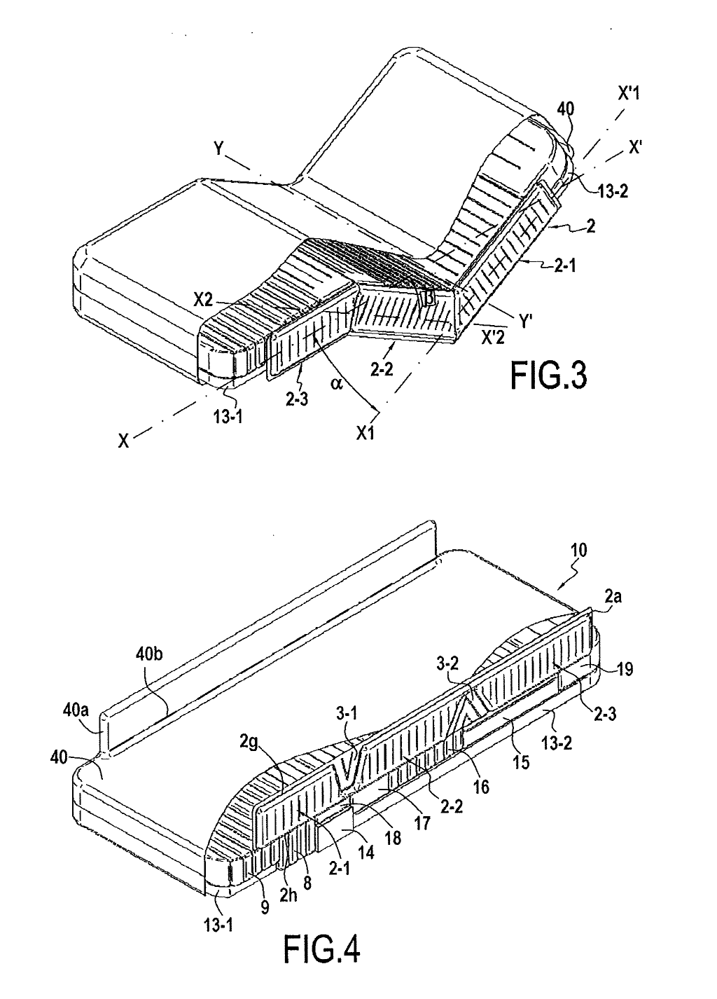

In some embodiments, said lateral cell 2a, 2b comprises at least one air space area, such as at least two air space areas 3-1, 3-2 comprising at least in part, or even entirely comprising, non-inflatable flexible material, providing the connection between two parts 2-1, 2-2, 2-3 of said cells adjacent to said air space area and located on either side of the air space in the longitudinal XX′ direction of said cell, said air space area 3-1, 3-2 being capable of enabling the folding of said cell 2a, 2b around said air space area, such that the longitudinal X₁X′₁, X₂X′₂ direction of said part of said lateral cell can be inclined α,β with respect to the longitudinal XX′ direction of another part of said cell located on the other side of said air space area as shown in FIG. 3. In FIG. 3, the X₁X′₁ direction of a part 2-1 is inclined α=60° with respect to the X₁X′₁ direction of part 2-3 and X₂X′₂ of the center part 2-2 is inclined β=30° with respect to the X₁X′₁ direction of head part 2-1.

It is known that said air space areas 3-1, 3-2 can be obtained from material in the area between the two adjacent parts 2-1, 2-2 and 2-3 of cells 2a, 2b located on either side of said air space area. However, cutting and removing too much material in said air space areas would possibly affect the proper behavior of said cells, such as good vertical behavior.

As this type of cell comprises two said air space areas 3-1, 3-2 it is particularly suited for following the inclines of the base or frame parts on which it rests when said bed base or bed frame is articulated in the illustrated manner. In this case, it will be understood that said air space area 3-1, 3-2 is located with respect to an articulation area 11-1, 11-2 of said bed base or bed frame. Each said cell 2a, 2b can thus retain an unchanged homogeneous width despite its folding in the vicinity of said air space areas 3-1 and 3-2 for following the incline of a part of a bed base or frame on which it rests and dividing said cell into three parts 2-1, 2-2 and 2-3.

Typically, an articulated bed base or bed frame comprises at least two articulations 11-1, 11-2, specifically a first articulation 11-2 located near the division between the sacrum area 16 and back area 15 and a second articulation 11-1 with respect to the knees, that is to say near the division between thigh area 17 and calf area 18, enabling the delimiting of the three following base or frame areas:
a first part supporting said head area 19 and back area 15 of the mattress,
a second part supporting sacrum area 15 and thigh area 17 of the mattress, and
a third part supporting calf area 18 and heel area 19 and said retractable area.

It is thus possible to raise head 19 and chest 15 areas at a positive angle a with respect to the horizontal in order to raise the patient's chest and simultaneously inclining in the opposite direction thigh area 17 and sacrum area 15 at a negative angle β with respect to the horizontal by lowering the articulation area 11-2 at the sacrum level delimiting said first part supporting the head 19 and back 15 areas and second part supporting the thigh 17 and sacrum 15 areas, then, if necessary, an elevation of the third part supporting the heel 9 and calf 18 areas, as well as retractable area 8, these latter three being kept horizontal by elevation of the bed base or bed frame located downstream of the second articulation 11-1 located with respect to the knee.

In some embodiments, said air space area comprises said opposed faces of said cell joined one against the other by at least one weld line, optionally a plurality of said weld lines, possibly forming chevrons. In the illustrative example, said cell 2a, 2b comprises two air space areas 3-1, 3-2 respectively including a first air space area 3-1 in the shape of a flared upwards ‘V’ and a second air space area 3-2 in the shape of a flared reverse or downwards ‘V.’

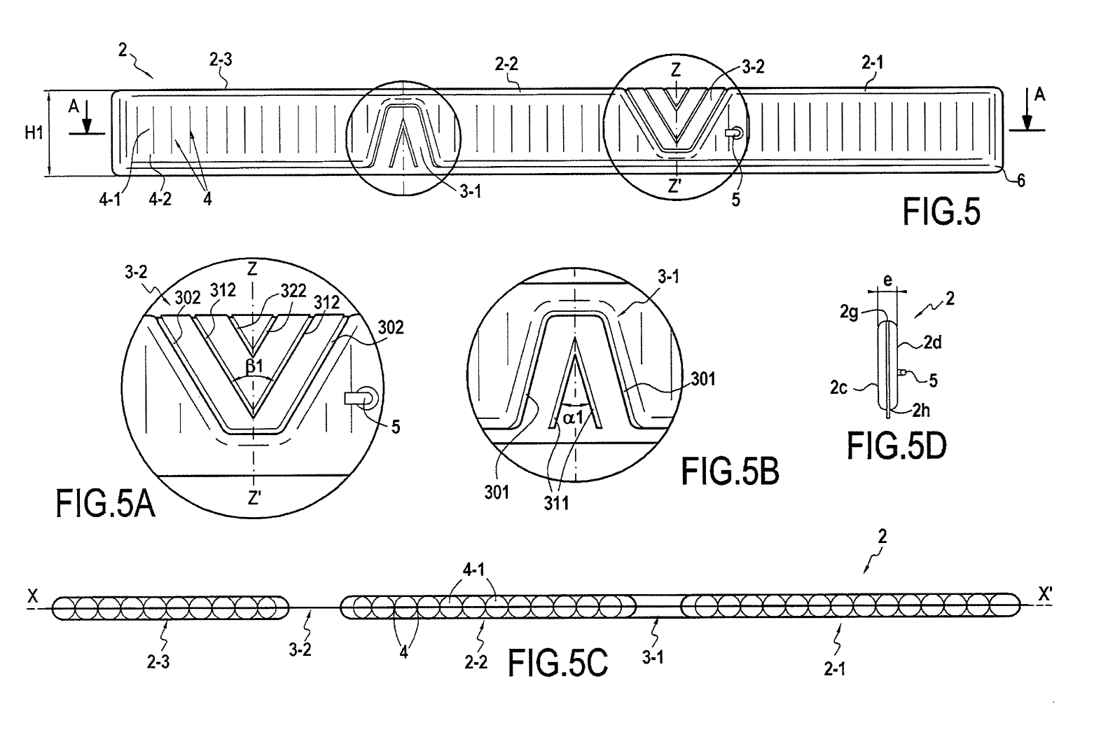

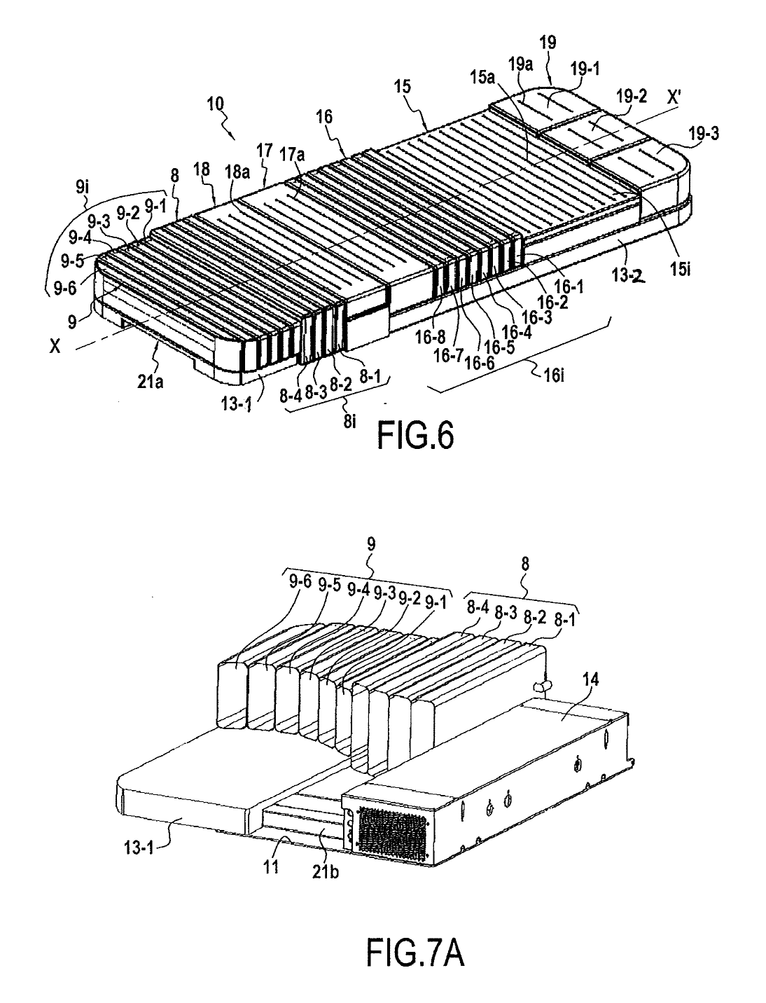

It will be understood that such ‘V’ and reverse ‘V’ shapes of said air space areas are compatible with the direction of inclination of various articulated bed base or bed frame parts according to the above-described operation, as well as the value of the angles α₁ of the ‘V’ of area 3-1 and β₁ of the ‘V’ of area 3-2 in FIGS. 5, 5a and 5b in which α₁=30° and β₁=60°.

It will also be understood that, if necessary, said ‘V’ and reverse ‘V’ shapes are delimited by weld lines 301-311, 302, 312, 322 joining the two opposed faces 2c, 2d of each of said cells 2a, 2b.

In some embodiments, said air space areas comprise a plurality of weld lines forming chevrons 301-311 and reverse chevrons 302, 312, 322, thus ensuring suitable joining of the two opposed lateral faces 2c, 2d of said lateral cell 2a, 2b in said air space areas 3-1, 3-2.

Said ‘V’ and reverse ‘V’ shapes and, if applicable, the angles α₁ and β₁ of said chevrons formed by said inclined weld lines make it possible to maintain the various parts of said cell 2a, 2b perpendicular to the level of the base or frame part on which they rest, following articulation and inclination of said parts of the bed base or bed frame. This layout promotes good vertical behavior of said cell 2a, 2b and to a suitable compressibility.

An angle α₁ of the ‘V’ of area 3-1 makes an inclination possible of part 2-2 with respect to part 2-1, that is to say, an angle (X₁X′₁, X₂X′₂=180°−α₁=150°). Likewise, an angle β₁ of the ‘V’ of air space area 3-2 makes possible an inclination of head part 2-1 with respect to center part 2-2 of an angle (X₁X′₁, X₂X′₂=180°−β₁=120°).

It will be understood that cells 2a, 2b each including two said air space areas 3-1, 3-2, as described above, is suited for resting on a bed base or bed frame with two articulations 11-1, 11-2 in order to enable a raising by positive inclination of a part of the end specifically before the bed base or bed frame and simultaneously a negative inclination of a part located between the two air space areas as will be explained in the detailed description of an embodiment below.

In some embodiments, said cells 2a, 2b are capable of being raised to a height above the level of the upper surface of said transverse cells of the mattress, and thus temporarily constitute, if desired, a lining, a barrier or an inflated border and/or a protection against a barrier 12 of said frame.

In the illustrative embodiment, said mattress 10 is covered by a slipcover 40 covering said transverse cells of the mattress and capable of covering said cells 2a, 2b when the latter are in a lowered position, and said slipcover comprises optionally a separate compartment 40a capable of being released from said slipcover after opening a zipper 40b, said separate compartment 40a being capable of covering said cells 2a, 2b in said raised position.

Also in the illustrative embodiment, said longitudinal cells 2a, 2b have a height H1 greater than that h of said transverse cells of the mattress; such as, for example, cells 2a, 2b having a height H1 more or less equal to that of said transverse cells, with the addition, where applicable, of height h1 of lower mattresses or layers 13-1, 13-2, on which said transverse cells of the mattress rest, specifically h=13 cm and h1=7 cm in the illustrative example. Furthermore, in some embodiments, the width e (see FIG. 5D) of said cells 2a, 2b is, in the inflated state, from about 2 to about 10 cm, such as 3 to 5 cm and their height H1 of about 20 cm.

As shown in FIG. 4, cells 2a, 2b are raised by pivoting each of cells 2a, 2b around its upper edge in the lowered position, which, following the pivoting, becomes the lower edge of cells 2a, 2b in raised position. As such, the lower edge 2g in the lowered position becomes the upper edge 2g in raised position of each of cells 2a, 2b. Likewise, the ‘Vs’ of air space areas 3-1 and 3-2 are reversed by pivoting between the lowered position and the raised position of cells 2a, 2b. In some embodiments, said transverse cells of the mattress and/or said cells 2a, 2b are comprised of plastic material, such as PVC or PU (polyurethane) or of cloth coated with said plastic material, such as PVC or polyurethane.

In some embodiments, said transverse cells of said retractable area 8 and/or said cells 2a, 2b of the mattress are filled with air regulated at a regulated pressure determined and controlled by said pressure regulation means, which in some instances includes a pump and electronic control means of the pump for opening or closing of the various electromagnetic valves controlling the opening and closing of the air feed and evacuation orifices of the different pneumatically independent cells, as well as the electronic means of collecting of the internal pressure measured within the different pneumatically independent cells and the data collected concerning the morphology and position of the patient resting on the mattress from a sensor 50, said sensor being in general positioned under the mattress, in this case under the lower mattress of sacrum area 15, it being understood that a capacitive sensor will sometimes be used, as described in unpublished patent application FR 0953758 of Jun. 5, 2009 on behalf of the applicant incorporated herein by reference.

Cells 2a, 2b in the raised position and covered by a substantially watertight and/or wipeable slipcover, can likewise serve as a barrier for preventing the harmful lateral runoff of fluids that might otherwise come back into contact with electrical bed parts under voltage and/or can run the risk of causing contamination, for example, when care is provided to the patient. The cells 2a, 2b can then be returned to a lowered position.

Cells 2a, 2b thus define an inside space inflatable on-demand, compartmentalized vertically in order to ensure a suitable compressibility effect when they are regulated at a therapeutic pressure, like the transverse cells of the mattress. However, when they are used in elevated position to serve as temporary lateral barrier, they will be inflated at maximum pressure in some embodiments.

It should likewise be noted that the shape of air space areas 3-1, 3-2 and the shape of the various chevron welds 301, 311, 302, 312, 322 make it possible to provide good verticality and perpendicularity of lateral cushions 2a, 2b when the bed is articulated, specifically in the vicinity of the bending of the knee and/or the articulation of the adjustable backrest as described above.

Air space areas 3-1, 3-2 are sized according to the desired angles for articulation of the mattress and thus the lateral cushions 2a, 2b after folding, such as having lines 301, 311 of area 302 inclined at a 15° angle with respect to the vertical, while lines 302, 312 and 322 of area 3-2 are inclined at a 30° angle with respect to the vertical. The ‘V’ weld lines make it possible to predetermine a folding direction of the lateral cushions 2a, 2b compatible with the direction of articulation of the various parts of bed frame 11 around articulations 11-1 and 11-2.

Lateral cells 2a, 2b are fixed to the mattress by snap fasteners and/or longitudinal zippers in some embodiments. Because said lateral cells 2a, 2b are inflatable and deflatable, it is possible to adjust the width of the mattress 10 and to change the width of the mattress to a given width corresponding to the length of said transverse cells when said lateral cells are deflated, for example, a mattress width of 85 cm, to a new wider width when at least one said lateral cell is inflated and an additionally greater width, when the two lateral cells, one respectively positioned on each side of the mattress, are inflated. Thus, for example, it is possible with 3.5 cm wide lateral cells in said transverse direction for mattress 10 to go from an 85 cm width with said lateral cells 2a, 2b deflated to 92 cm wide with two lateral cells 2a, 2b inflated.

Although certain illustrative embodiments have been described in detail above, many embodiments, variations and modifications are possible that are still within the scope and spirit of this disclosure as described herein and as defined in the following claims.

1. A mattress comprising
at least one first cell inflated with air, the at least one first cell situated in a first region of the mattress, the first region begin located between a head end and foot end of the mattress,
at least one second cell inflated with air, the at least one second situated adjacent the foot end of the mattress, and
a plurality of third cells positioned between the at least one first cell and the at least one second cell, the plurality of third cells being inflatable and the plurality of third cells being deflatable to permit horizontal movement of the at least one second cell toward the at least one first cell to change a length of the mattress with the at least one first cell and the at least one second cell remaining inflated.

2. The mattress of claim 1, wherein each cell of the plurality of third cells extends transverse to a longitudinal direction of the mattress and each cell of the plurality of third cells being pneumatically independent of each other cell of the plurality of third cells.

3. The mattress of claim 1, wherein the at least one first cell comprises a plurality of first cells that extend transverse to the longitudinal direction of the mattress, the at least one second cell comprises a plurality of second cells that extend transverse to the longitudinal direction of the mattress, further comprising a first layer underlying the plurality of first cells, and further comprising a second layer underlying the plurality of second cells, the second layer moving with the plurality of second cells toward the first layer as the plurality of second cells move toward the plurality of first cells.

4. The mattress of claim 3, wherein a horizontal gap is defined between the first and second layers and lower end regions of the plurality of third cells are situated in the gap.

5. The mattress of claim 3, wherein a height of the plurality of third cells when inflated is substantially equal to a height of the plurality of first cells plus a height of the first layer.

6. The mattress of claim 3, wherein a height of the plurality of third cells when inflated is substantially equal to a height of at least one second cell of the plurality of second cells plus a height of the second layer.

7. The mattress of claim 6, wherein an upper surface of the second layer slopes downwardly toward the foot end of the mattress.

8. The mattress of claim 3, further comprising a guide that guides the movement of the plurality of second cells toward the plurality of first cells.

9. The mattress of claim 8, wherein the second layer has a chamber and the guide comprises a rail over which the second layer slides as the plurality of second cells move relative to the plurality of first cells.

10. The mattress of claim 9, further comprising a unit housing pneumatic components, the unit being situated inside the mattress and the rail extending toward the foot end of the mattress from the unit.

11. The mattress of claim 9, wherein middle regions of each cell of the plurality of third cells are situated atop the rail when the plurality of third cells are inflated and wherein bottom ends of laterally outer regions of each cell of the plurality of third cells are situated outboard of opposite sides of the rail when the plurality of third cells are inflated.

12. The mattress of claim 1, further comprising a pair of side cells extending longitudinally along lateral ends of the at least one first cell, the at least one second cell, and the plurality of third cells, wherein the at least one second cell moves relative to the pair of side cells in a space defined between foot end regions of the pair of side cells when the at least one second cell moves toward the at least one first cell.

13. The mattress of claim 12, wherein the pair of side cells are inflatable and deflatable to change a width of the mattress.

14. The mattress of claim 13, wherein each side cell of the pair of side cells comprises at least one non-inflatable flexible area that provides a connection between inflatable parts of the side cell, the at least one non-inflatable flexible area facilitating pivoting of the inflatable parts relative to each other as sections of a bed frame which supports the mattress is articulated.

15. The mattress of claim 12, wherein each side cell of the pair of side cells is pivotable to a raised position to provide a cushion between a patient supported on the mattress and a barrier of a bed frame supporting the mattress.

16. The mattress of claim 1, wherein the at least one second cell comprises a heel support region of the mattress.

17. The mattress of claim 1, further comprising an additional cell interposed between the at least one first cell and the plurality of third cells.

18. The mattress of claim 1, further comprising a head area including three pneumatically independent cells including a central cell and two lateral cells positioned on opposite sides of the central cell.

19. The mattress of claim 18, wherein each of the lateral cells is independently inflatable and deflatable such that when one or the other or both of the lateral cells are deflated, a patient's head remains supported by the central cell.

20. The mattress of claim 1, further comprising a distance measuring device situated inside the mattress and operating to measure a distance between the at least one first cell and the at least one second cell.
